(19) United States
(12) Patent Application Publication
(10) Pub. No.: US 2024/0234758 A1
(43) Pub. Date: Jul. 11, 2024

(54) RECIRCULATION GAS FLOW CONTROL AND DISTRIBUTION MODULE FOR FUEL CELLS

(71) Applicant: Eaton Intelligent Power Limited, Dublin (IE)

(72) Inventors: Vardhan D. PATANKAR, Pune (IN); Nihal SUKHATANKAR, Pune (IN); Shilpa KHOPADE, Pune (IN); Milos TOULEC, Ricany (CZ); Amol CHAUDHARI, Pune (IN); Shubham GURJAR, Madhya Pradesh (IN); Suraj THAPA, Bagdogra (IN); Udit Bhaveshkumar SHAH, Gandhinagar (IN); Kavish MEHTA, Maharashtra (IN)

(21) Appl. No.: 18/557,499

(22) PCT Filed: Apr. 26, 2022
(86) PCT No.: PCT/EP2022/025185

§ 371 Date: Oct. 26, 2023

(30) Foreign Application Priority Data
Apr. 26, 2021 (IN) 202111019076

(51) Int. Cl. H01M 8/04111; F04C 18/12; H01M 8/04089; H01M 8/04313; H01M 8/04746

(52) U.S. Cl. CPC H01M 8/04111; F04C 18/126; H01M 8/04097; H01M 8/04313; H01M 8/04776; F04C 2240/40

(57) ABSTRACT

A recirculation gas flow control and distribution assembly that includes an electric motor and a pump coupled to the electric motor. The pump includes a pump housing with a pump inlet and a pump outlet. The pump inlet is fluidly connected to a recirculated gas. At least one nozzle is directly connected to the pump housing. A passage is formed in the pump housing and nozzle linking the pump inlet to the nozzle. An injector is coupled to the nozzle, the injector is fluidly connected to a fuel. A valve is disposed in the passage, the valve is movable between open and closed positions. The recirculated gas is selectively passed to the pump outlet and fuel is selectively feed into the nozzle.

### FIELD OF THE INVENTION

The invention relates to gas flow control and distribution modules for fuel cells

### BACKGROUND OF THE INVENTION

Traditional automotive vehicles utilize internal combustion engines such as diesel, gas or two stroke engines to propel the vehicle. Electric vehicles with fuel cells require high performance as well as high durability of recirculation systems. In some constructions, a hydrogen recirculation pump recirculates hydrogen into a fuel cell stack. Hydrogen recirculation systems are utilized for increasing fuel use and increasing durability of fuel cell stacks.

There is a need for improved recirculation systems that may increase performance, increase durability, reduce parasitic loads, or otherwise increase efficiency of a fuel cell system.

### SUMMARY OF THE INVENTION

In one aspect, there is disclosed a recirculation gas flow control and distribution assembly that includes an electric motor and a pump coupled to the electric motor. The pump includes a pump housing with a pump inlet and a pump outlet. The pump inlet is fluidly connected to a recirculated gas. At least one nozzle is directly connected to the pump housing. A passage is formed in the pump housing and nozzle linking the pump inlet to the nozzle. An injector is coupled to the nozzle, the injector is fluidly connected to a fuel. A valve is disposed in the passage, the valve is movable between open and closed positions. The recirculated gas is selectively passed to the pump outlet and fuel is selectively feed into the nozzle.

In another aspect, there is disclosed a method of operating a recirculation gas flow control and distribution assembly comprising the steps of: providing a recirculation gas flow control and distribution assembly including an electric motor; a pump coupled to the electric motor, the pump including a pump housing with a pump inlet and a pump outlet, the pump inlet fluidly connected to a recirculated gas; at least one nozzle directly connected to the pump housing; a passage formed in the pump housing and nozzle linking the pump inlet to the nozzle; an injector coupled to the nozzle, the injector fluidly connected to a fuel; and a valve disposed in the passage, the valve movable between open and closed positions; providing a fuel cell fluidly coupled to the recirculation gas flow control and distribution assembly; feeding fuel through the injector into the nozzle; determining a target stoichiometric ratio of the fuel cell; calculating ΔSR; and selectively energizing the electric motor based on the calculated value of ΔSR.

### BRIEF DESCRIPTION OF THE DRAWINGS

FIG. 1 is a perspective view of a hydrogen recirculation apparatus including a pump, nozzle, and injector;

FIG. 2 is a cross-sectional view of the hydrogen recirculation system of FIG. 1;

FIG. 3 is a functional schematic of a hydrogen recirculation system including the apparatus of FIG. 1 in interaction with a fuel cell stack and a fuel source;

FIG. 4 is functional a schematic of the hydrogen recirculation system including the apparatus of FIG. 1 in interaction with a plurality of fuel cell stacks and a fuel source;

FIG. 5 is a functional schematic of the hydrogen recirculation apparatus of FIG. 1 operating in a pump and nozzle mode;

FIG. 6 is a functional schematic of the hydrogen recirculation apparatus of FIG. 1 operating in an nozzle-only mode;

FIG. 7 is a functional schematic of the hydrogen recirculation system of FIG. 1 operating in a pump-only mode;

FIG. 8 is a graph depicting a control process for the hydrogen recirculation system of FIG. 1;

FIG. 9 is a perspective view of recirculation apparatus including a hydrogen pump, a plurality of nozzles, and a plurality of injectors;

FIG. 10 is a cross-sectional view of the hydrogen recirculation apparatus of FIG. 9;

FIG. 11 is a functional schematic of the hydrogen recirculation apparatus of FIG. 9 in interaction with a plurality of fuel cell stacks and a fuel source.

### DETAILED DESCRIPTION OF THE PREFERRED EMBODIMENTS

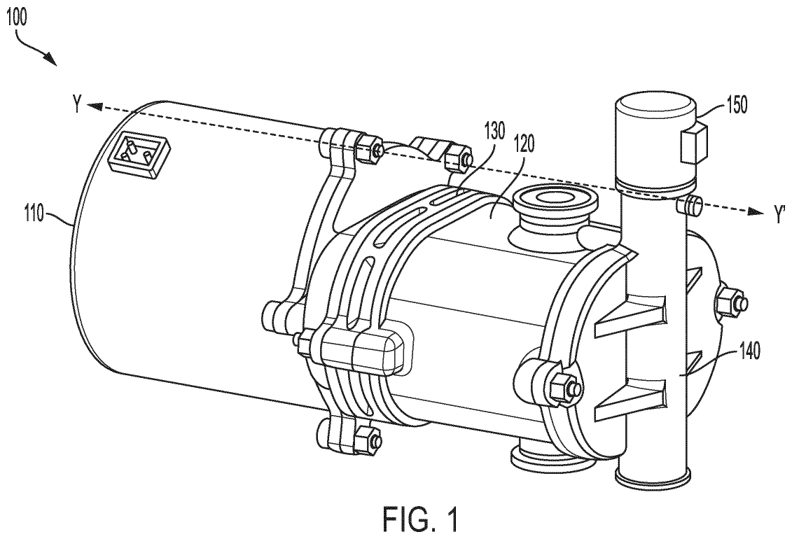

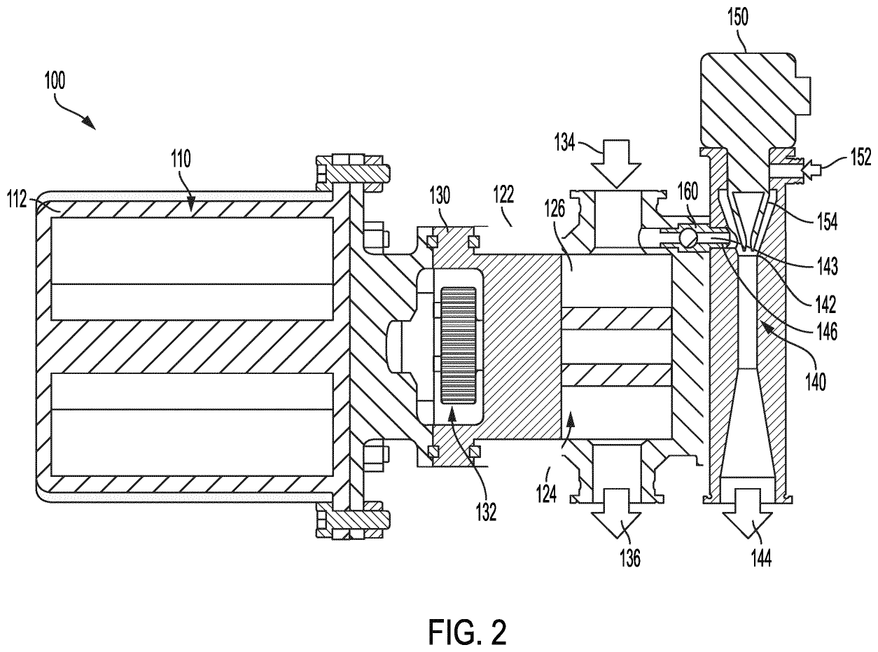

Referring to FIGS. 1 and 2, FIG. 1 depicts a perspective view of a recirculation gas flow control and distribution assembly 100 and FIG. 2 depicts a partial cross-sectional view of the recirculation gas flow control and distribution assembly 100 taken along line Y-Y′.

The recirculation gas flow control and distribution assembly 100 includes an electric motor 110, and a pump 120 coupled to the electric motor 110. The pump 120 may include various types of pumps including centrifugal, rigid vane, positive displacement and Roots.

In the depicted embodiment, the pump 120 is a Roots device, and includes a gear assembly 130, a nozzle 140, an injector 150, and a valve 160. The electric motor 110 includes a housing 112. The pump 120 is coupled to the electric motor 110. The pump 120 includes a housing 122 that defines an internal volume 124. Housing 122 may be formed a material that is generally inert or non-reactive to a fuel source. In some embodiments, the interior of the housing 122 that is exposed to the interior volume 124 may include a coating that is inert to the fuel source. For instance, the housing 122 may include stainless steel and the fuel source may include hydrogen. The pump 120 further includes rotors 126 disposed in the internal volume 124. The rotors 126 are coupled to the electric motor 110. The electric motor 110 may be coupled with the rotors 126 by the gear assembly 130. The gear assembly 130 may include a gear set 132. The gear set 132 may include appropriate gears, such as one or more timing gears. While two rotors 126 are shown, it is noted that embodiments may include other or different rotors 126, gear assemblies 130, or other components.

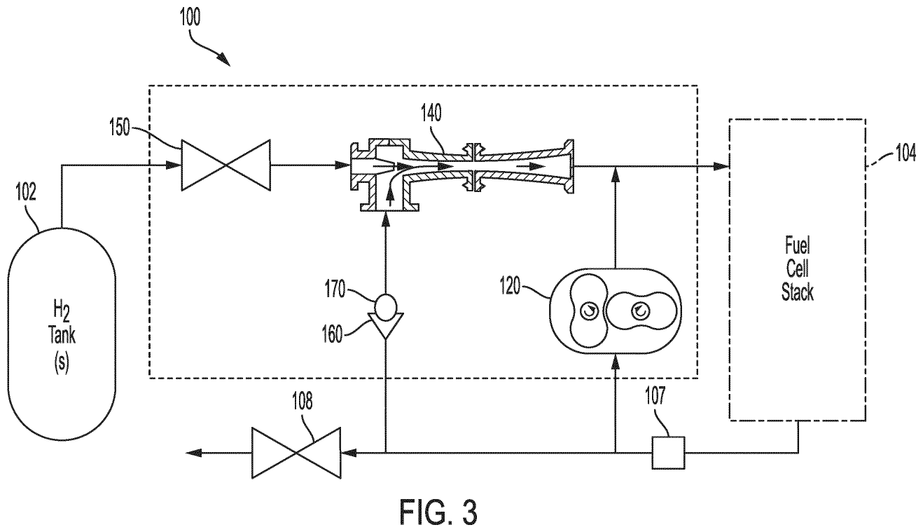

Turning to FIG. 3, while referencing FIGS. 1-2, a functional schematic of the recirculation gas flow control and distribution assembly 100 illustrates interaction of the hydrogen recirculation gas flow control and distribution assembly 100 with a fuel cell stack 104 and a fuel source 102. The pump 120 may be directly coupled with the nozzle 140. In one aspect, the pump housing 122 is directly connected to the nozzle 140. In another aspect, the pump housing 122 may be monolithically formed with the nozzle 140. The nozzle 140 may be coupled with the injector 150. The injector may be a flow control valve or a metering valve. The injector 150 may be a continuous type or a pulse modulated type valve. The injector may be connected to a controller 170 that may actively instruct the injector 150 to control a flow of the fuel. The controller 170 may include an electronic control unit that may include a computer processor and non-transitory computer readable memory storing computer readable instructions.

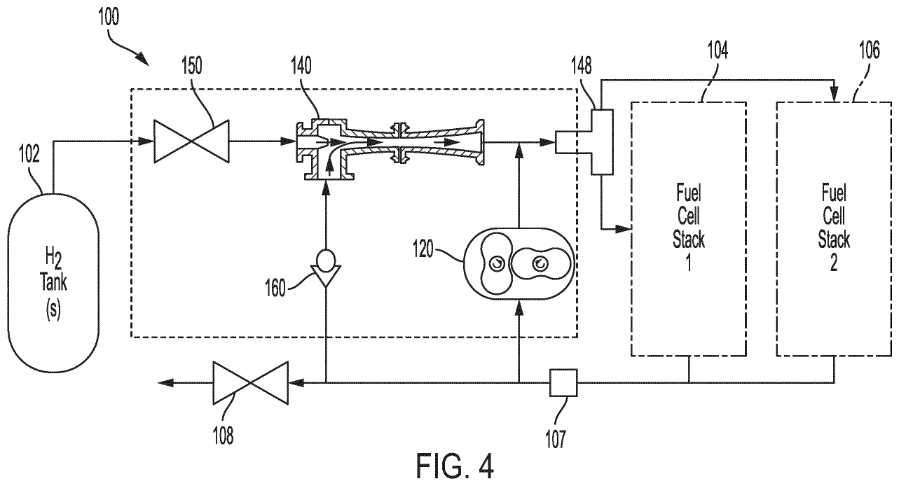

The injector 150 may include an inlet 152 and an outlet 154. The inlet 152 may be fluidly connected to a fuel source 102. The fuel source 102 may include a fuel tank that contains a fuel, such as hydrogen. It is noted that other fuel sources may be utilized. The inlet 152 may selectively receive the fuel and provide the fuel to the outlet 154. The outlet 154 may be fluidly connected to an inlet 142 of the nozzle 140. The nozzle 140 may include an outlet 144 that is fluidly connected with one or more inlets of one or more fuel cell stacks 104 and/or 106 (FIG. 4).

Still referring to FIGS. 1-3, the pump 120 includes an inlet 134 and an outlet 136. The inlet 134 is fluidly coupled with an outlet of one or more fuel cell stacks 104 and/or 106 (FIG. 4), which may additionally be coupled to a water trap assembly 107 and a purge valve 108. The inlet 134 may allow for flow of a fluid (e.g., in a gaseous state) into the internal volume 124 of the pump 120. The fluid may be pumped from the internal volume 124 to an outlet 136 of the pump 120. The outlet 136 of the pump 120 is fluidly connected with one or more inlets of one or more fuel cell stacks 104 and/or 106 (FIG. 4).

In embodiments, the inlet 142 and/or a secondary inlet 146 of the nozzle 140 and the inlet 134 of the pump 120 may be selectively, fluidly coupled via the valve 160. The secondary inlet 146 is defined by a passage 143 that links the inlet 134 of the pump 120 to the nozzle 140. The valve 160 may be a valve that is selectively positioned in a closed state or open state. The position of the valve 160 may be controlled actively or passively. For instance, a controller 170 may actively instruct the valve 160 to be in a closed or open state. The controller 170 may include an electronic control unit that may include a computer processor and non-transitory computer readable memory storing computer readable instructions. In another example, the valve 160 may passively open or close based on a pressure.

The pump 120 may be integrated with nozzle 140. The nozzle 140 may be press fit with the pump housing 122 providing a modular apparatus.

The fuel cell stack 104 outlet is connected to inlet 134 of the pump 120 and the inlet 142 and/or the secondary inlet 146 of the nozzle 140. The outlet 136 of the pump 120 and the outlet 144 of the nozzle 140 can be combined using a connector.

Embodiments described herein may be particularly advantageous for various fuel cell applications that require high performance as well as high durability and therefore utilize controlled recirculation of a gas, such as hydrogen. For instance, embodiments may be particularly beneficial for Fuel Cell Electric Vehicles (FCEVs) including but not limited to passenger vehicles, buses, MD&HD Trucks, or other vehicles, as well as power back-up solutions and any other similar fuel cell applications.

FIG. 4 is a functional schematic of the recirculation gas flow control and distribution assembly that illustrates interaction with a fuel cell stack 104, a fuel cell stack 106, and a fuel source 102. The recirculation gas flow control and distribution assembly 100 may be utilized with any appropriate number of fuel cell stacks. While two fuel cell stacks 104, 106 are shown, additional fuel cell stacks may be utilized. In embodiments, vehicles may utilize additional fuel cells for increased power outputs, such as in some commercial vehicles. The recirculation gas flow control and distribution assembly may include a diverter valve 148 that is appropriately sized for the pump 120, nozzle 140, and/or injector 150. In one aspect, the recirculation gas flow control and distribution assembly may be utilized when all the connected fuel cell stacks are being operated at the same current load.

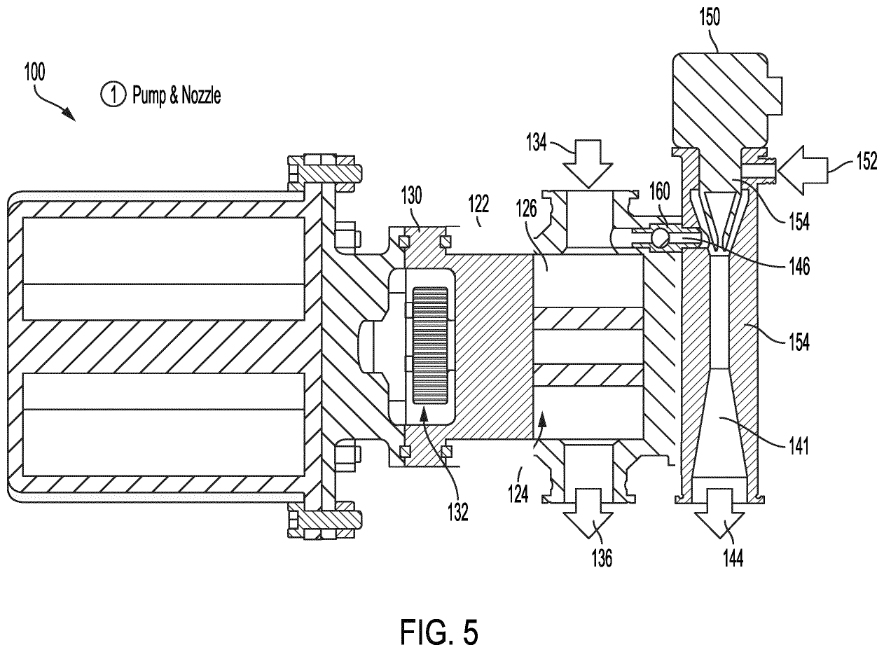

Referring to FIGS. 5-7, illustrated is the recirculation gas flow control and distribution assembly 100 operating in a pump and nozzle mode, a nozzle-only mode, and a pump-only mode, respectively.

In FIG. 5, the inlet 134 of the pump 120 and inlet 152 of the injector 150 receive recirculated gas and fuel such as hydrogen. The valve 160 is in an open position. This allows the fluid flow through the pump 120 and through an inner pathway 141 of the nozzle 140 and out of the outlet 144. The rotors 126 are driven at a determined speed or speeds to pump the gas through the internal volume 124 and out of outlet 136. In this mode, the pump 120 supports the nozzle 140 to provide recirculation flow during high stoichiometric ratio demands.

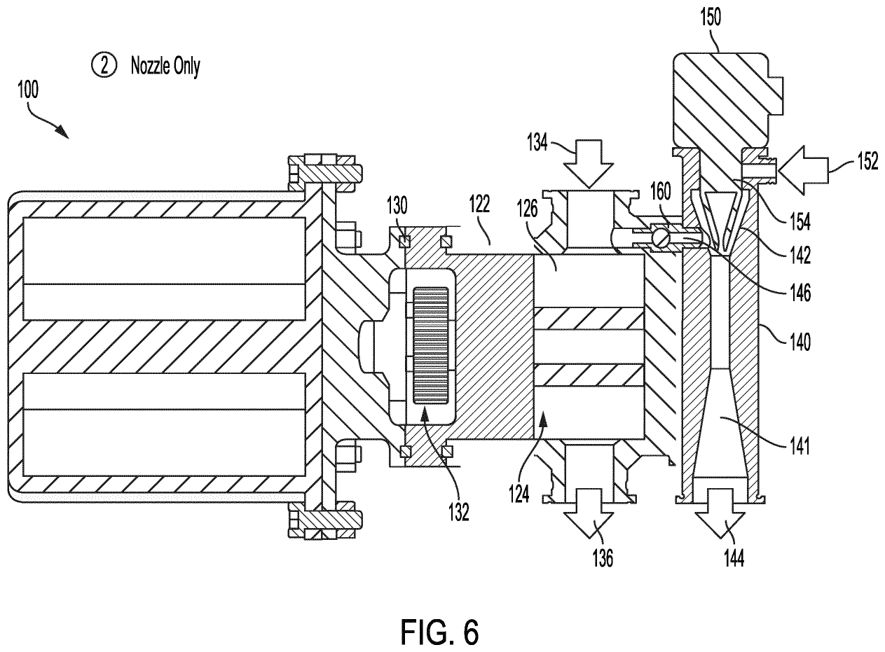

In FIG. 6, the pump 120 is stopped such that there is no pumping of the gas through the internal volume 124. The valve 160 is in an open position. The gas and fuel is allowed to flow from the inlet 142 and/or the secondary inlet 146 through the inner pathway 141 of the nozzle 140 and out of the outlet 144. In this mode, the nozzle 140 provides flow during low stoichiometric ratio demand. The nozzle 140 may be more efficient at low stoichiometric ratio demands than at high stoichiometric ratio, such that the pump 120 does not need to support the nozzle 140.

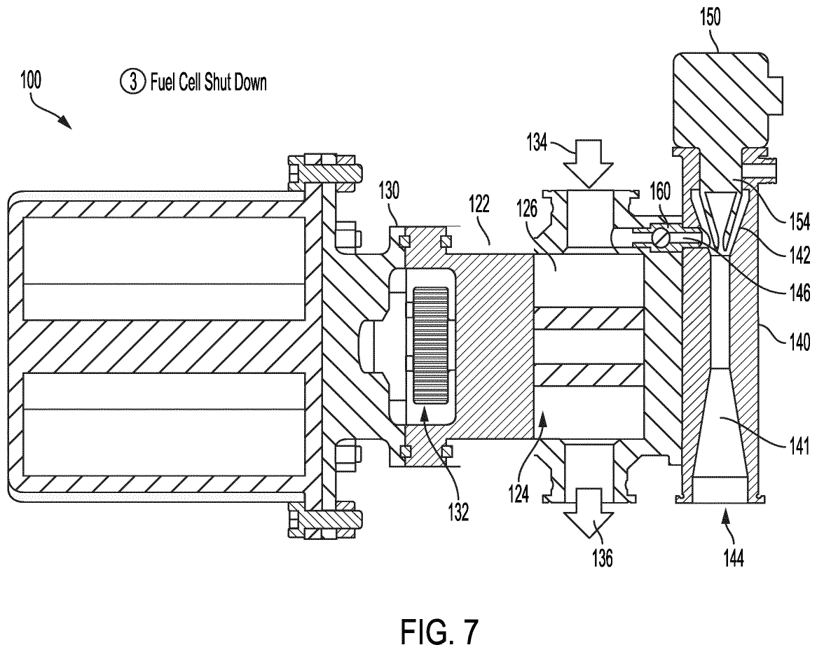

In FIG. 7, the injector 150 is shut down and the valve 160 is closed. This prevents fuel and recirculated gas from passing through the nozzle 140. The pump 120 is operating to draw hydrogen in the recirculated gas through the internal volume 124 and out of outlet 136. For example, during fuel cell shutdown, hydrogen in the recirculation gas flow control and distribution assembly 100 will be circulated and consumed in the fuel cell stack (e.g., fuel cell stack 104, fuel cell stack 106, etc.).

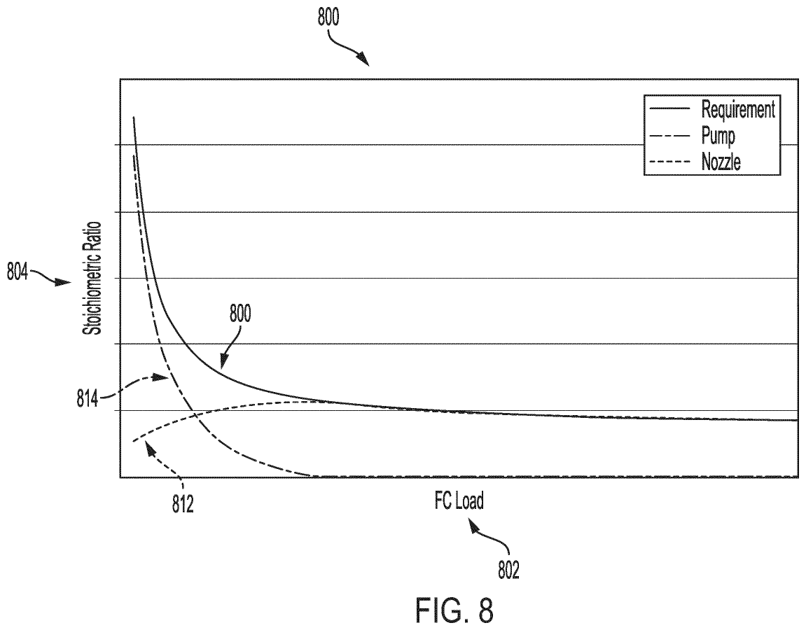

Turning to FIG. 8 with reference to FIGS. 1-7, illustrated is a graph 800 depicting a control process for the recirculation gas flow control and distribution assembly. In the graph 800, the x-axis 802 illustrates fuel cell load and the y-axis 804 illustrates a stoichiometric ratio. The stoichiometric ratio may be defined as the ratio of hydrogen supplied by the system relative to the amount of hydrogen required in a fuel cell reaction.

Line 810 illustrates a target stoichiometric ratio at given fuel cell loads. Line 812 illustrates a nozzle portion of the stoichiometric ratio at given fuel cell loads, and line 814 illustrates the pump portion of the stoichiometric ratio at given fuel cell loads.

ΔSR may be defined as the difference between the stoichiometric ratio required at the fuel cell inlet denoted by the line 810 and the stoichiometric ratio at the nozzle outlet denoted by line 812.

Where ΔSR is greater than zero, the pump 120 and the nozzle 140 may both provide circulation of hydrogen and recirculated gas to the fuel cell, as shown in FIG. 5. The speed of the electric motor 110 may be controlled based on the amount of recirculated gas containing hydrogen gas which is not able to entrain into the nozzle and is therefore provided by the pump 120.

As ΔSR approaches zero, the circulation of hydrogen is provided by the nozzle 140 and the electric motor 110 of pump 120 is stopped such that the stoichiometric contribution of the pump is zero, as shown in FIG. 6. When the electric motor 110 is stopped, the recirculated gas flowing to the nozzle 140 is provided by suction created at the secondary inlet 146 to the nozzle 140. The fuel passing through the nozzle 140 entrains the recirculated gas, as the valve 160 is in an open position. The suction may be controlled by the flow rate of hydrogen through the injector 150.

During normal operation, the valve 160 is in an open position allowing the flow of hydrogen and recirculated gas as described above. In a zone where the hydrogen gas flow is transitioning between the flow described in FIG. 5 where the pump 120 and nozzle 140 provide flow and the nozzle only flow of FIG. 6, the valve may be modulated between open and closed positions such that back flow into the pump 120 is avoided.

The pump 120 may be activated on demand when the recirculation gas flow control and distribution assembly is operating in the nozzle only mode shown in FIG. 6. For example, the pump 120 may be activated to handle sudden overloads in fuel or hydrogen demand from a steep demand in power that can be supplied by the further action of the pump 120. Additionally, the pump 120 may be activated to handle an increased amount of Nitrogen in the system such as before a purging operation. When the nitrogen content of the recirculated gas reaches a predetermined level, such as 10 percent, the pump 120 may provide the required hydrogen flow which is not able to entrain into the nozzle even after the hydrogen flow rate through the injector 150 has been increased.

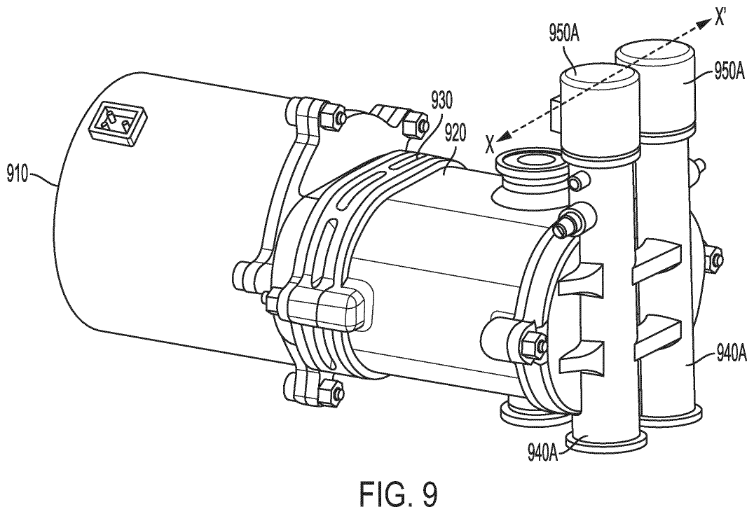

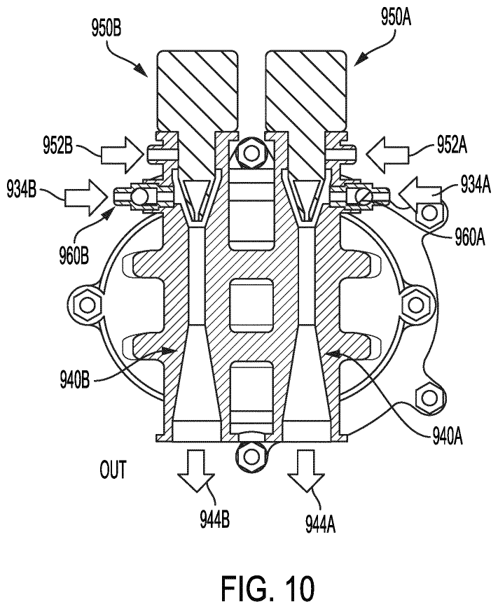

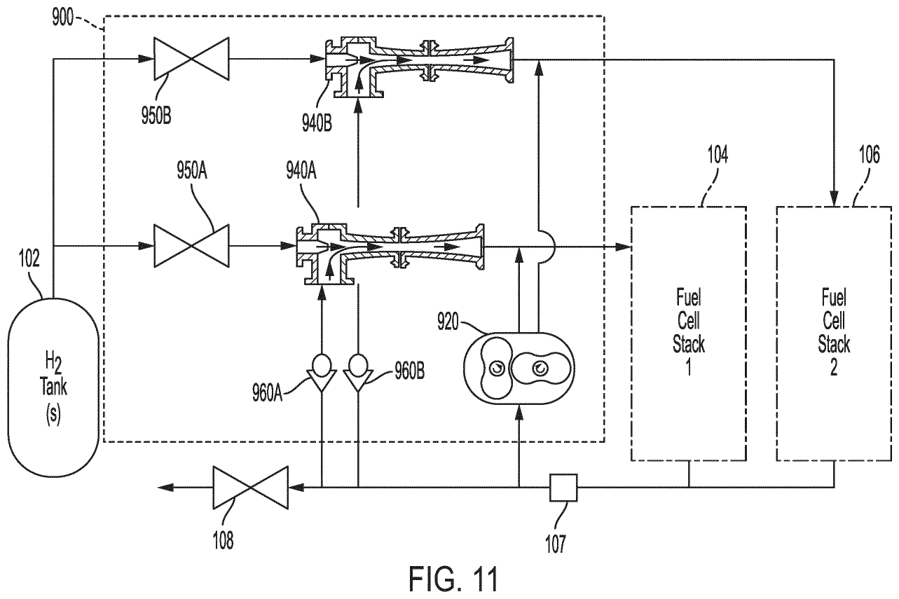

FIGS. 9-11 illustrate a recirculation gas flow control and distribution assembly 900 that includes a plurality of nozzles (e.g., nozzle 940A, 940B) independently operable to provide recirculation of gas and fuel to a plurality of fuel cell stacks (e.g., fuel cell stacks 104, 106). FIG. 9 depicts a perspective view of a recirculation gas flow control and distribution assembly 900 and FIG. 10 depicts a partial cross-sectional view of the recirculation gas flow control and distribution assembly 900 taken along line X-X′. The recirculation gas flow control and distribution assembly 900 primarily includes an electric motor 910, a pump 920, a gear assembly 930, a nozzle 940A, a nozzle 940B, an injector 950A, injector 950B, valve 960A, and valve 960B. Like named components of recirculation gas flow control and distribution assembly 100 and recirculation gas flow control and distribution assembly 900 may comprise similar or the same components. For instance, electric motor 110 and electric motor 910 may comprise similar constructions.

In embodiments, the valve 960A may be openable or closable to selectively allow a flow of recirculated gas to nozzle 940A. Similarly, the valve 960B may be openable or closable to selectively allow a flow of recirculated gas to nozzle 940B. As described herein, the valves 960A and 960B may be passively controlled or actively controlled (e.g., via a controller). This may allow the nozzles 940A and 940B to operate at different times or in different modes. For instance, the valve 960A may be open while the valve 960B is closed, such that nozzle 940A recirculates gas and or hydrogen from inlet 934A to outlet 944A, while nozzle 940B does not recirculate gas and or hydrogen from inlet 934B to outlet 944B.

The control of the various components of the hydrogen recirculation apparatus 900 may be similar to that described above with reference to hydrogen recirculation apparatus 100 described above with reference to FIG. 8, but with two nozzles 940A and 940B and two fuel cells 104, 106. In one aspect, either of the nozzles 940A and 940B may be operated in a pump and nozzle mode as described above or in a nozzle only mode as described above.

1. A recirculation gas flow control and distribution assembly comprising:
an electric motor;
a pump coupled to the electric motor, the pump including a pump housing with a pump inlet and a pump outlet, the pump inlet fluidly connected to a recirculated gas;
at least one nozzle directly connected to the pump housing;
a passage positioned between the pump housing and nozzle linking the pump inlet to the nozzle;
an injector coupled to the nozzle, the injector fluidly connected to a fuel;
a valve disposed in the passage, the valve movable between open and closed positions;
wherein the recirculated gas is selectively passed to the pump outlet and fuel is selectively feed into the nozzle.

2. The recirculation gas flow control and distribution assembly of claim 1 wherein the nozzle is press fitted with the pump housing.

3. The recirculation gas flow control and distribution assembly of claim 1 wherein an outlet of the nozzle is fluidly coupled to an inlet of at least one fuel cell.

4. The recirculation gas flow control and distribution assembly of claim 1 wherein an outlet of the nozzle is fluidly coupled to an inlet of a plurality of fuel cells.

5. The recirculation gas flow control and distribution assembly of claim 1 wherein the outlet of the pump is fluidly coupled to an inlet of at least one fuel cell.

6. The recirculation gas flow control and distribution assembly of claim 1 wherein the outlet of the pump is fluidly coupled to an inlet of a plurality of fuel cells.

7. The recirculation gas flow control and distribution assembly of claim 1 wherein the pump includes rotors disposed in the pump housing, the rotors linked to the electric motor by a gear train.

8. The recirculation gas flow control and distribution assembly of claim 1 wherein the inlet of the pump is fluidly connected with an outlet of at least one fuel cell.

9. The recirculation gas flow control and distribution assembly of claim 1 wherein the inlet of the pump is fluidly connected with an outlet of a plurality of fuel cells.

10. The recirculation gas flow control and distribution assembly of claim 1 including a plurality of nozzles directly connected to the pump housing.

11. The recirculation gas flow control and distribution assembly of claim 10 further including a plurality of injectors coupled to the plurality of nozzles, the plurality of injectors fluidly connected to a fuel.

12. A method of operating a recirculation gas flow control and distribution assembly comprising the steps of:
providing a recirculation gas flow control and distribution assembly including an electric motor; a pump coupled to the electric motor, the pump including a pump housing with a pump inlet and a pump outlet, the pump inlet fluidly connected to a recirculated gas; at least one nozzle directly connected to the pump housing; a passage positioned between the pump housing and nozzle linking the pump inlet to the nozzle; an injector coupled to the nozzle, the injector fluidly connected to a fuel; and a valve disposed in the passage, the valve movable between open and closed positions;
providing a fuel cell fluidly coupled to the recirculation gas flow control and distribution assembly;
feeding fuel through the injector into the nozzle;
determining a target stoichiometric ratio of the fuel cell;
calculating ΔSR;
selectively energizing the electric motor based on the calculated value of ΔSR.

13. The method of operating a recirculation gas flow control and distribution assembly of claim 12 wherein when ΔSR is greater than zero energizing the electric motor recirculating gas to an inlet of the fuel cell.

14. The method of operating a recirculation gas flow control and distribution assembly of claim 13 including the step of controlling a speed of the electric motor based on an amount of recirculated gas passed through the passage due to entrainment of the fuel through the nozzle.

15. The method of operating a recirculation gas flow control and distribution assembly of claim 12 wherein when ΔSR is less than or equal to zero de-energizing the electric motor wherein recirculating gas is drawn through the passage into the nozzle.

16. The method of operating a recirculation gas flow control and distribution assembly of claim 12 wherein when a shutdown command is received from the fuel cell, moving the valve to the closed position, halting flow of fuel through the injector and energizing the electric motor recirculating gas to an inlet of the fuel cell.

17. The method of operating a recirculation gas flow control and distribution assembly of claim 12 including the step of modulating the valve between open and closed positions as ΔSR approaches zero.

18. The method of operating a recirculation gas flow control and distribution assembly of claim 12 including the step of energizing the electric motor when ΔSR is less than or equal to zero in response to a sudden overload in fuel demand.

19. The method of operating a recirculation gas flow control and distribution assembly of claim 12 including the step of energizing the electric motor when the nozzle cannot entrain the flow due to change in recirculated composition.

20. The method of operating a recirculation gas flow control and distribution assembly of claim 12 including the step of controlling the injector regulating a flow of fuel.
